(19) United States
(12) Patent Application Publication
(10) Pub. No.: US 2019/0186891 A1
(43) Pub. Date: Jun. 20, 2019

(54) Rotation-Angle Sensor, Stator Element and Rotor Element for Same

(71) Applicant: Robert Bosch GmbH, Stuttgart (DE)

(72) Inventors: Fabian Utermoehlen, Lippstadt (DE); Andreas Merz, Freiberg Am Neckar (DE)

(73) Assignee: Robert Bosch GmbH, Stuttgart (DE)

(21) Appl. No.: 16/311,335

(22) PCT Filed: Jun. 29, 2017
(86) PCT No.: PCT/EP2017/066149

§ 371 Date: Dec. 19, 2018

(30) Foreign Application Priority Data
Jun. 30, 2016 (DE) 10 2016 211 832.3

(51) Int. Cl. G01B 7/30; G01D 5/20; G01D 5/244; H02K 3/28; H01F 5/04

(52) U.S. Cl. CPC G01B 7/30; G01D 5/2073; H01F 5/04; G01D 5/24438; H02K 3/28; G01D 5/2053

(57) ABSTRACT

A rotation-angle sensor comprises a stator element and a rotor element mounted to rotate relative to the stator element about an axis of rotation. The rotation angle is detectable by an inductive coupling between the rotor element and the stator element. A compensation element is located on the stator element and has a compensation transmitter coil to emit an electromagnetic compensation alternating field and a compensation receiver coil to receive electromagnetic alternating fields. The rotor element has a first electrically conductive portion, which is both located on the rotor element and inductively coupled to the compensation transmitter coil and the compensation receiver coil such that when the compensation transmitter coil emits the electromagnetic compensation alternating field, an alternating voltage induced in the compensation receiver coil is primarily dependent on a relative mutual radial location of the stator element and the rotor element with respect to the axis of rotation.

### PRIOR ART

The invention relates to a rotation angle sensor, a stator element and a rotor element for the same.

By arranging transmitting and receiving coils at the stator of a rotation angle sensor, said coils being coupled inductively to a target on the rotor in such a way that when an electromagnetic alternating field is emitted by the transmitting coil an alternating voltage is induced in the receiving coil, the rotation angle can be detected depending on the induced alternating voltage. This is described, for example, in EP 0 909 955 B1.

### DISCLOSURE OF THE INVENTION

The invention is based on the recognition that errors can occur with real sensors as a result of bearing play or tolerances related to manufacture in terms of the relative position of the stator element and the rotor element, said errors being, for example, so large that a specification relating to the accuracy of the measured rotation angle can no longer be satisfied.

There may therefore be a need to provide a rotation angle sensor that even in the presence of radial deviations of the stator element or of the stator relative to the rotor element or the rotor from an ideal position, e.g. a centered position, to compensate for the changes in the measurement signal for the angle detection that occur thereby.

### Advantages

It is therefore the object of the present invention to provide an improved rotation angle sensor.

This object is fulfilled by the rotation angle sensor as claimed in claim 1, and the stator element along with the rotor element as claimed in the subsidiary claims.

Further advantageous embodiments of the present invention are given in the dependent claims.

A corresponding rotation angle sensor comprises a stator element and a rotor element mounted rotatably about a rotation axis with respect to the stator element, wherein the rotation angle can be detected by an inductive coupling between the rotor element and the stator element, wherein at least one compensation element is arranged at the stator element, wherein the at least one compensation element comprises at least one compensation transmitting coil for emitting an electromagnetic compensation alternating field and at least one compensation receiving coil for receiving electromagnetic alternating fields, wherein the rotor element comprises at least one first electrically conducting section, wherein the at least one first electrically conducting section at the rotor element is arranged in such a way and is coupled inductively in such a way with the at least one compensation transmitting coil and the at least one compensation receiving coil of the compensation element that when the electromagnetic compensation alternating field is transmitted by the at least one compensation transmitting coil, a compensation alternating voltage induced in the at least one first compensation receiving coil depends predominantly on a relative radial arrangement of the stator element and of the rotor element to one another with reference to the axis of rotation.

It is obvious in this case that the compensation alternating voltage can also depend on the rotation angle. The compensation element is, however, preferably designed such that a pure rotary movement in a defined arrangement between the rotor element and the stator element only changes the compensation alternating voltage slightly if at all. Only a radial displacement between the stator element and the rotor element, e.g. an eccentric arrangement resulting from bearing play with respect to the axis of rotation, should change the compensation alternating voltage measurably. Preferably the compensation alternating voltage changes in terms of its magnitude or amplitude depending on and/or proportionally to the deviation from the defined radial arrangement. The amplitude can, for example, rise with an increasing deviation in a radial direction. It can be provided that the compensation alternating voltage is only sensitive to displacement along one direction in a Cartesian axis system. The provision of two compensation elements that are arranged non-collinearly with respect to the axis of rotation and each other can then enable a sensitivity also to displacements in all directions in a plane perpendicular to the axis of rotation.

In the sense of this application, an “electrically conducting” section can also be understood as an “electrically conductive section”. It should be understood here that in the sense of this application, the materials that are generally identified as or used as insulators are not considered to be “electrically conducting” or “electrically conductive”. Purely by way of example, a metal sheet can be electrically conducting or electrically conductive.

The compensation alternating voltage is induced in the at least one first compensation receiving coil by the emission of the electromagnetic compensation alternating field. The first electrically conducting section of the rotor element, which can also be known as what is called a target, is used here for the inductive coupling. The inductive coupling depends here on the relative radial arrangement of the target and the compensation element. The target is arranged on the rotor element, the compensation element is arranged on the stator element. The relative radial arrangement of the rotor element and the stator element thus influences the induced compensation alternating voltage, depending on the inductive coupling between the compensation element and the target. By monitoring the induced compensation alternating voltage, the relative radial arrangement of the rotor element and the stator element can thus be monitored. Depending on the relative overlap of the at least one compensation receiving coil by the first electrically conducting section of the rotor element or by the target, the amplitude of the voltage induced by the compensation transmitting coil changes.

Advantageously, the stator element comprises at least one angle detection transmitting coil for emitting an electromagnetic angle detection alternating field and at least one angle detection receiving coil for detecting electromagnetic alternating fields, wherein the rotor element comprises at least one second electrically conducting section. The at least one second electrically conducting section can here, for example, be designed in the form of a circular ring sector with respect to the axis of rotation. The at least one second electrically conducting section is here inductivley coupled to the at least one angle detection receiving coil in such a way that when the electromagnetic angle detection alternating field is emitted by the at least one angle detection transmitting coil at least one angle detection alternating voltage is induced in the at least one angle detection receiving coil, wherein the at least one second electrically conducting section is arranged at the rotor element in such a way that the first alternating voltage induced in the at least one angle detection receiving coil depends on an angle of rotation between the stator element and the rotor element. The angle detection alternating voltage induced is, in particular, advantageously, predominantly dependent on an angle of rotation between the stator element and the rotor element. This results in a particularly compact arrangement, since the second section relevant for the angle detection and the first section relevant for the compensation can be constructed in a single target, e.g. in the rotor element or rotor.

Advantageously, the at least one compensation element, or the at least one compensation receiving coil, lies radially outside the at least one angle detection receiving coil. A radial deviation can thereby be recognized particularly reliably, since the mutual influence between angle detection coils and compensation coils is thereby minimized.

Advantageously, the at least one compensation transmitting coil for generating the compensation alternating field, and the at least one angle detection transmitting coil for generating the angle detection alternating field are arranged at the stator element. This permits a simplified cabling or conductive track configurations for contacting the coils.

Advantageously, the at least one angle detection transmitting coil is arranged radially outside, surrounding the at least one angle detection receiving coil. This permits a particularly compact form of construction on a circuit board. The stator element can particularly advantageously thus be arranged on a single circuit board.

Advantageously, the winding of the at least one compensation receiving coil with respect to the at least one first electrically conducting section is arranged, radially with respect to the axis of rotation, at least partially overlapping with the first electrically conducting section. In this way, for example, the radial extent of the first electrically conducting section can be smaller than the radial extent of the at least one compensation receiving coil.

As a result, a change in the compensation alternating voltage, or a current value of this induced compensation alternating voltage, is particularly well detectable. The compensation alternating voltage is induced here by the electromagnetic compensation alternating field of the at least one compensation transmitting coil in the at least one first compensation receiving coil, with coupling of the at least one electrically conducting first section. Small changes in position of the at least one first electrically conducting section along the radial direction can be detected particularly precisely with these geometrical relationships. Thus even a small deviation in the relative radial arrangement of the stator element and the rotor element with respect to one another in respect of the axis of rotation is recognizable. Deviations from a defined reference position e.g. a centered position, between the stator element and the rotor element with respect to the axis of rotation can, for example, in this way be detected particularly accurately.

Advantageously, the at least one first electrically conducting section is an electrically conductive circular ring surrounding the rotor element in the circumferential direction. This permits the recognition of deviations even with only a single compensation element.

Advantageously, the at least one first electrically conducting section extends radially from the axis of rotation. The at least one second electrically conducting section here abuts the at least one first electrically conducting section radially, extending in the direction of the axis of rotation. The at least one second electrically conducting section is here arranged, viewed in the radial direction, between the axis of rotation and the at least one first electrically conducting section. Here, viewed in the radial direction, a gap or slot is provided between the at least one second electrically conducting section and the at least one first electrically conducting section. This can have the form of a circular ring sector, and can preferably extend in the circumferential direction. The geometric line at which the edge of the at least one first electrically conducting section and the edge of the at least one second electrically conducting section at facing sides of the respective section are bounded forms a boundary between the sections. The surface that the at least one first electrically conducting section and the at least one second electrically conducting section form at this boundary is preferably interrupted by the gap or slot. This enables an overlap between the at least one first electrically conducting section and the at least one compensation receiving coil, while the at least one second electrically conducting section is still at a distance therefrom. As a result, the robustness of the recognition in respect of parasitic inductive coupling by the second electrical section is increased.

Advantageously, the extent of the gap or slot in the radial direction is at least 50% of the difference between a radial extent of the compensation receiving coil and a radial extent of the at least one first conducting section. The functionality is thereby improved. In the centered case, i.e. when both the stator element and the rotor element are centered with respect to the axis of rotation, the at least one first electrically conducting section is, for example, in the center between the windings of the respective compensation receiving coil. With a maximum excursion radially inward, the at least one first electrically conducting section is preferably fully outside the windings of the angle detection receiving coil. In the case of an excursion radially outward, in which the at least one first conducting section lies still exactly just inside the compensation receiving coil, it is simultaneously ensured that the at least one second electrically conducting section does not yet overlap the compensation receiving coil radially inward, or only does so minimally. For this displacement radially outward, the at least one second electrically conducting section is thus arranged not yet overlapping the compensation receiving coil. The at least one first electrically conducting section preferably has a lower radial dimension than the radial extent of the at least one compensation receiving coil. The width of the gap or width of the slot is preferably dimensioned such that, with a radial displacement, the at least one second electrically conducting section does not overlap the at least one compensation element, meaning that the distance is large enough that no (strong) inductive coupling arises between the at least one second electrically conducting section and the at least one compensation element. In this way it is ensured that the at least one compensation element is only, or predominantly only, coupled with the at least one first electrically conducting section, and the compensation measurement results are not corrupted by the at least one second electrically conducting section that is intended for detecting the angle.

Advantageously the at least one second electrically conducting section and the at least one first electrically conducting section form a surface, in particular having the form of a circular ring sector, radially abutting one another with respect to the axis of rotation, wherein, in particular, the first conducting section comprises the gap or slot. This enables a simple, in particular one-piece, manufacture out of electrically conducting material. The gap or slot can here for example be stamped from a thin metal sheet.

Advantageously, the at least one compensation receiving coil comprises an identical number of first partial windings and second partial windings that are arranged with respect to one another, and with respect to the axis of rotation, such that a first alternating voltage component is induced by the electromagnetic compensation alternating field in the first partial winding, and a second alternating voltage component with the opposite arithmetic sign is induced in the second partial winding. The first alternating voltage component and the second alternating voltage component, here compensate themselves in a predetermined radial arrangement of the at least one first electrically conducting section with respect to the axis of rotation. In the above-mentioned radially central arrangement, the alternating voltages induced in the partial windings overlay to give a resulting voltage of preferably 0 V (zero volts). Deviations in the one or other direction are thus recognizable in the amplitudes of the induced voltage. For this purpose the partial windings are advantageously wound in mutually opposing directions. For example, with a centered arrangement of the rotor element and of the stator element with respect to the axis of rotation, or with a positioning corresponding to the reference position, this central arrangement of the at least one first electrically conducting section with respect to the at least one compensation receiving coil can be adjusted. An induced compensation alternating voltage thus compensates itself in the two partial windings.

A number of at least one compensation elements and of at least one first electrically conducting sections advantageously agree with one another. Advantageously two compensation receiving coils are arranged at the stator element in a predetermined circular segment between 0° and a maximum angle in the range of 170° to 190°, preferably 180°, wherein two first electrically conducting sections are provided at the rotor element in a predetermined circular segment between 0° and a maximum angle in the range of 170° to 190°, preferably of 180°. In addition, or as an alternative, at least two compensation receiving coils and at least two first electrically conducting sections are arranged offset by a predetermined angle, in particular between 70 and 100°, preferably 90° in the circumferential direction of the stator element or of the rotor element.

These are particularly favorable arrangements for a rotation angle sensor that is implemented as a rotation angle segment sensor. If, for example, a circular segment of 180° is chosen, the structural size of the rotation angle sensor can be halved in comparison with a circular segment of 360°. If, in addition, an offset of for example 90° is chosen, then on the one hand a Cartesian coordinate system with an origin in the axis of rotation can be defined such that two compensation receiving coils are arranged in the negative x-direction and in the positive x-direction at the same distance from the origin. On the other hand, a compensation receiving coil can be arranged in the positive y-direction at the same distance from the origin as these. Radial deviations of the relative arrangement of the rotor element with respect to the stator element can thereby be measured as a linear combination of the deviations along the x-axis and the y-axis. In this case, for example, in an idle position of the rotor element, three first electrically conducting sections can be arranged, offset by 90°, in the rotation angle sensor. Preferably two of the electrically conducting sections are arranged such that in this idle position they are arranged with the same distance from the origin in the negative x-direction and in the positive x-direction, and one of the electrically conducting first sections is arranged in the positive y-direction at the same distance as these from the origin. Through this, in the idle position, a deviation of the rotor element from its centered position in the x-direction and in the y-direction can be recognized. A horizontal and a vertical displacement are thus directly determined with vectorial measurement. With a 90° offset, x-tolerances and y-tolerances can in this way be measured directly, without conversion having to be done.

The invention also relates to a stator element and a rotor element of the type described for a rotation angle sensor.

### SHORT DESCRIPTION OF THE DRAWINGS

Preferred forms of embodiment of the present invention are explained in more detail below with reference to the appended drawings. Here:

FIG. 1 shows schematically a view of a part of a rotation angle sensor,

FIG. 2 shows schematically a view of a part of a stator for rotation angle sensors,

FIG. 3 shows schematically a part of the rotation angle sensor according to a first form of embodiment,

FIG. 4 shows schematically a detailed view of a part of the rotation angle sensor according to the first form of embodiment, FIG. 5a, 5b, 5c show schematically views of different relative arrangements of parts of the rotation angle sensor according to FIG. 4,

FIG. 6 shows schematically a rotor element according to a second form of embodiment.

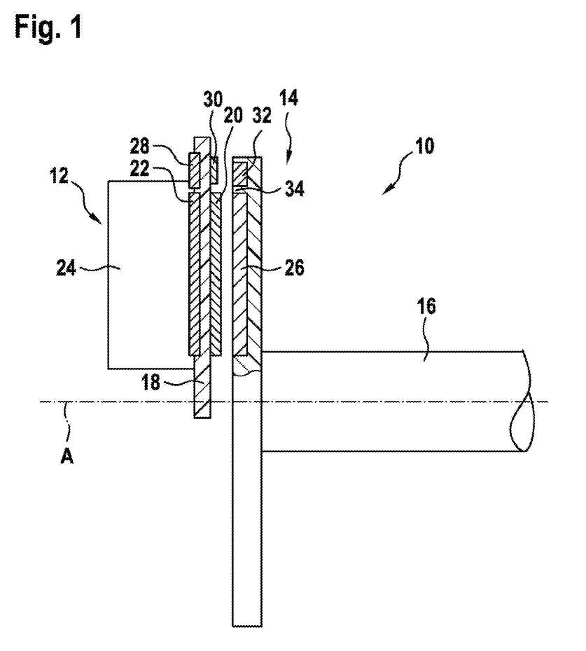

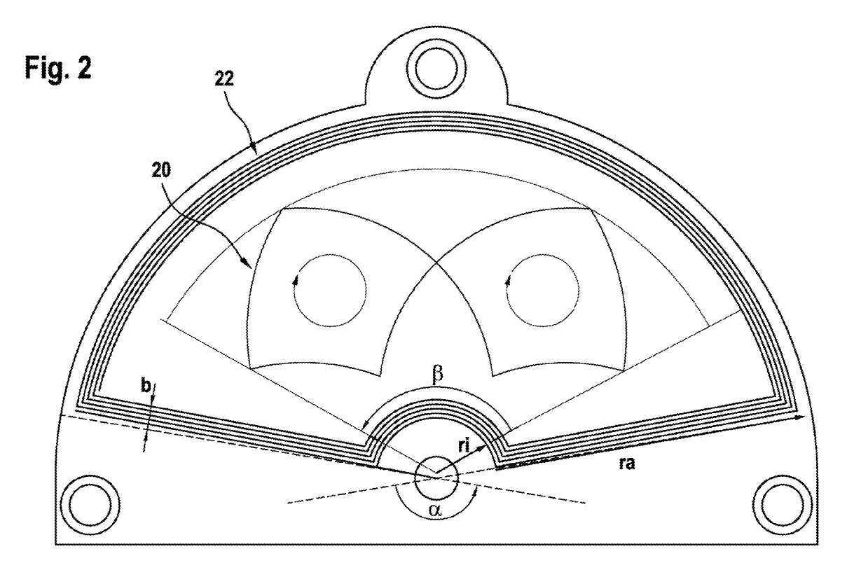

FIG. 1 shows schematically a rotation angle sensor 10, comprising a stator element 12 and a rotor element 14 mounted rotatably about an axis of rotation A with respect to the stator element 12.

The angle of rotation can be detected through an inductive coupling between the rotor element 14 and the stator element 12. Details of the inductive coupling and its use for the determination of the angle of rotation are described, for example, in EP 0 909 955 B1.

The stator element 12 accordingly, for example, comprises the at least one angle detection transmitting coil 22 illustrated in FIG. 1 for emitting an electromagnetic angle detection alternating field and at least one angle detection receiving coil 20 for detecting electromagnetic alternating fields.

“Radial” or “radial arrangement” below means a spoke-like direction or arrangement going away from the axis of rotation A. “Surrounding” or “circumferential direction” below means a circular direction, essentially on a plane perpendicular to the axis of rotation A. “Axial direction” below means a direction along the axis of rotation A.

A sensor circuit board for the rotation angle sensor 10 comprises, for example, at least one circumferentially arranged angle detection transmitting coil 22 which comprises one or a plurality of windings and is preferably implemented as a planar coil. The windings can advantageously be realized on a plurality of layers of a multi-layer circuit board in order to be able to generate a sufficiently large electromagnetic alternating field. The at least one angle detection transmitting coil 22 is subjected to an alternating voltage that has amplitudes in the range between 0.5 V up to 10 V, preferably 1.5 V, at frequencies in the range of a few megahertz, preferably 5 MHz.

FIG. 2 shows a layout of a known, exemplary sensor circuit board for a rotation angle sensor that is implemented as a rotation angle segment sensor. This means that coils running through 360° around the axis of rotation A are not provided, but that the coils are arranged with a predetermined opening angle α appropriate for a predetermined measuring range β of the rotation angle sensor. The measuring range β is also accordingly less than 360°. The measuring range β can in principle cover any angle between β=0° and β=360°; the measuring range β advantageously has the values β=360°/n. Here, n is a natural number greater than 1. In the example, the measuring range is β=120°. The opening angle α of the surrounding angle detection transmitting coil 22 is preferably 5° to 10° more than the measuring range β, in order to hold down the influence of the field non-homogeneities in the region of the radially extending conductive tracks of the at least one angle detection transmitting coil 22 on the at least one angle detection receiving coils 20. A relatively homogeneous flux linkage of the measuring range β is also achieved thereby.

The at least one angle detection transmitting coil 22 comprises conductive tracks extending radially that are connected together through arcs. The arc-shaped conductive tracks are bounded on the inside by an inner radius ri and on the outside by an outer radius ra. The outer radius ra is, for example, limited by the available construction space, and is a few tens of millimeters in size, and preferably 25 mm. The inner radius ri is of a sufficiently large dimension to permit a shaft feed-through, but can also be 0 mm if this is not required. In order to increase the field strength, the at least one angle detection transmitting coil 22 can be implemented on a plurality of layers of the sensor circuit board.

At least one angle detection receiving coil 20, which is composed for example of two partial windings, through each of which electrical current flows in different directions when current is flowing (clockwise or anticlockwise) extends, for example, in the interior of the at least one angle detection transmitting coil 22. The partial windings can be formed on different layers of the circuit board, particularly at the crossover points of the windings.

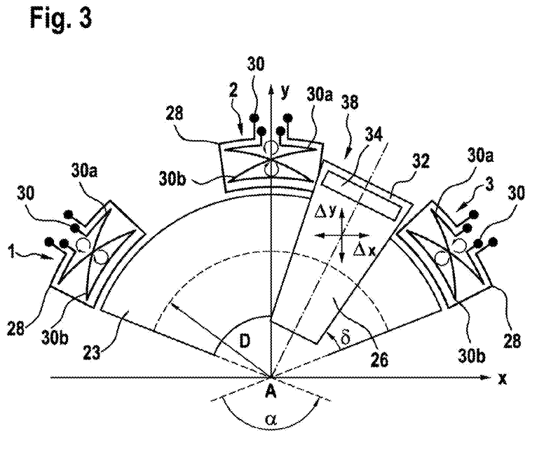

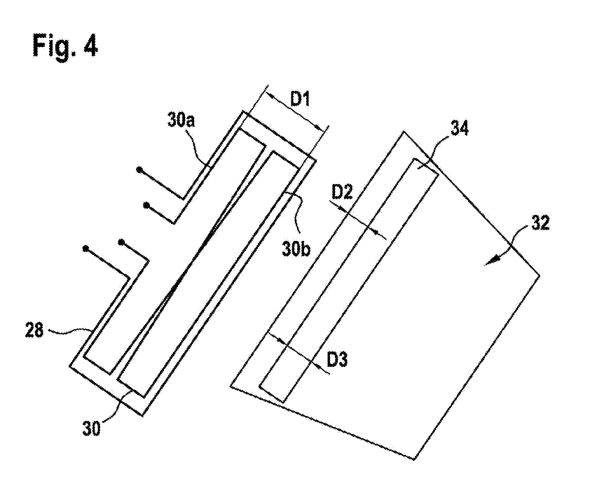

FIG. 3 shows a plan view of a first form of embodiment of the rotation angle sensor 10. The rotation angle sensor 10 comprises a coil arrangement 23. In the example, this is implemented according to the arrangement of the at least one angle detection transmitting coil 22 and of the at least one angle detection receiving coil 20 that is described in FIG. 2. The rotor element 14 comprises at least one first electrically conducting section 32, and, in addition, at least one second electrically conducting section 26.

The at least one second electrically conducting section 26 is preferably implemented in the form of a circular ring sector with respect to the axis of rotation A. Other forms, such as for example rectangular form or circular form or general polygons are also possible.

The at least one second electrically conducting section 26 is coupled inductively to the at least one angle detection receiving coil 20 in such a way that, when the electromagnetic angle detection alternating field is emitted by the at least one angle detection transmitting coil 22 at least one angle detection alternating voltage is induced in the at least one angle detection receiving coil 20. The at least one second electrically conducting section 26 is arranged at the rotor element 14 in such a way that the angle detection alternating voltage induced in the at least one angle detection receiving coil 20 depends primarily on a rotation angle between the stator element 12 and the rotor element 14. Details on the arrangement of the at least one angle detection transmitting coil 22, the at least one angle detection receiving coil 20, and the at least one second electrically conducting section 26, as well as details for determining the rotation angle, are known, for example, from EP 0 909 955 B1.

In addition, at least one first compensation element 1, a second compensation element 2, and a third compensation element 3 are arranged at the stator element.

Each of these compensation elements 1, 2, 3 comprises at least one compensation transmitting coil 28 for emitting an electromagnetic compensation alternating field and at least one compensation receiving coil 30 for receiving electromagnetic alternating fields.

The at least one first electrically conducting section 32 is arranged at the rotor element 14 in such a way, and is inductively coupled with the at least one compensation transmitting coil 22 and the at least one compensation receiving coil 30 of the respective compensation element 1, 2, 3 in such a way that when the electromagnetic compensation alternating field is emitted by the at least one compensation transmitting coil 28, a compensation alternating voltage induced in the at least one first compensation receiving coil 30 depends primarily on a relative radial arrangement of the stator element 12 and the rotor element 14 to one another with respect to the axis of rotation A. The inductive coupling takes place, for example, as described for the rotation angle detection. The coupling factor, which is to say an amplitude relationship between the voltage of the compensation receiving coil 30 and the voltage of the compensation transmitting coil 22, thus supplies information about a relative position of the respective first electrically conducting section 32 to the respective compensation element 1, 2, 3, and thus, in particular about the relative radial position of the stator element 12 with respect to the rotor element 14.

The at least one compensation transmitting coil 28 for generating the compensation alternating field and the at least one angle detection transmitting coil 22 for generating the angle detection alternating field are arranged, for example, at the stator element 12 as illustrated in FIG. 1.

Alternatively, the compensation receiving coil 30 can be arranged inside the angle detection transmitting coil 22 at the stator element 12. In this way, the rotation angle sensor 10 or the stator element 12 can have an even smaller construction, or an even smaller diameter.

The at least one compensation element 1, 2, 3, or the at least one compensation receiving coil 30, lies preferably parallel to a plane that extends essentially perpendicular to the axis of rotation A. Preferably, the at least one compensation element 1, 2, 3, or the at least one compensation receiving coil 30, does not overlap the area of the at least one angle detection receiving coil 20, when viewed as a projection onto the plane perpendicular to the axis of rotation A. Preferably, the at least one compensation element 1, 2, 3, or the at least one compensation receiving coil 30, lies here radially outside the at least one angle detection receiving coil 30, i.e. further away therefrom when viewed from the axis of rotation A.

The winding of the at least one compensation receiving coil 30 can be arranged to overlap at least partially with respect to the at least one first electrically conducting section 32 radially with respect to the axis of rotation A in a centered position of the rotor element 14 and stator element 12, wherein, for example, the radial extent of the at least one first electrically conducting section 32 is smaller than the radial extent of the at least one compensation receiving coil 30.

According to the first form of embodiment, the at least one first electrically conducting section 32 is designed essentially in the form of a circular ring sector. The at least one first electrically conducting section 32 extends, according to the first form of embodiment, from the axis of rotation A radially outward. Instead of a circular ring sector form, a different form, for example rectangular form or circular form, can also be used.

The at least one second electrically conducting section 26 abuts the at least one first electrically conducting section 32 when viewed radially, and extends in the direction of the axis of rotation A. The at least one second electrically conducting section 26 is, if viewed in the radial direction, arranged between the axis of rotation A and the at least one first electrically conducting section 32. Viewed in the radial direction, a gap 34 or slot 34, preferably having the form of a circular ring sector preferably extending in the circumferential direction, is provided between the at least one second electrically conducting section 26 and the at least one first electrically conducting section 32. The gap 34 or slot 34 can also have a rectangular form or another form.

Preferably the at least one second electrically conducting section 26 and the at least one first electrically conducting section 32, abutting each other radially with respect to the axis of rotation A, constitute a surface 38 having in particular the form of a circular ring sector, wherein in particular the at least one first electrically conducting section 32 comprises the gap 34 or the slot 34. The surface 38 can be given by a different form, for example by a rectangular form or a circular form.

The coil arrangement 23 with the angle detection transmitting coil 22 is illustrated schematically in FIG. 3. The angle detection transmitting coil 22 is arranged in a circular arc segment of δ=20° to δ=160° anticlockwise with respect to the x-axis. Its central radial extension D is shown with dashes, and adopts values between a few tens of millimeters and a few hundred millimeters, for example between 10 mm and 200 mm. The opening angle of the arrangement is α=140°. Other angles are also possible.

FIG. 3 shows a plan view of an arrangement of a stator element 12 and a rotor element 14. 3 compensation elements 1, 2, 3 are arranged at the stator element 12 and the coil arrangement 23. The coil arrangement 23 can here be designed, for example, as in FIG. 2. The rotor element 12 is illustrated, purely by way of example for the purposes of greater clarity, with only one single trapezoidal rotor section that is formed from the first conducting section 32, the gap 34 and the second conducting section 26. It is clear that the rotor element can also comprise a plurality of, for example, identical rotor sections 32, 34, 26. For example, just as many rotor sections 32, 34, 26 are provided as compensation elements 1, 2, 3. It is also however possible for a smaller or larger number of rotor sections 32, 34, 26 to be provided than the number of compensation elements 1, 2, 3. For example, two, three or four rotor sections 32, 34, 26 are provided. The rotor sections 32, 34, 26 can also have the form of a circular sector or the form of a circular ring sector.

The illustrated arrangement with the first compensation element 1, the second compensation element 2 and the third compensation element 3 are formed in a circular arc segment of δ=20° to δ=160°. The individual compensation elements 1, 2, 3 extend, for example as in FIG. 3, in a first circular arc segment of δ=25° to δ=50°, in a second circular arc segment from δ=77.5° to δ=102.5°, and in a third circular arc segment from δ=130° to δ=155°. The first compensation element 1, the second compensation element 2 and the third compensation element 3 here, viewed radially, have a greater distance from the axis of rotation A than the outer radius ra of the coil arrangement 23.

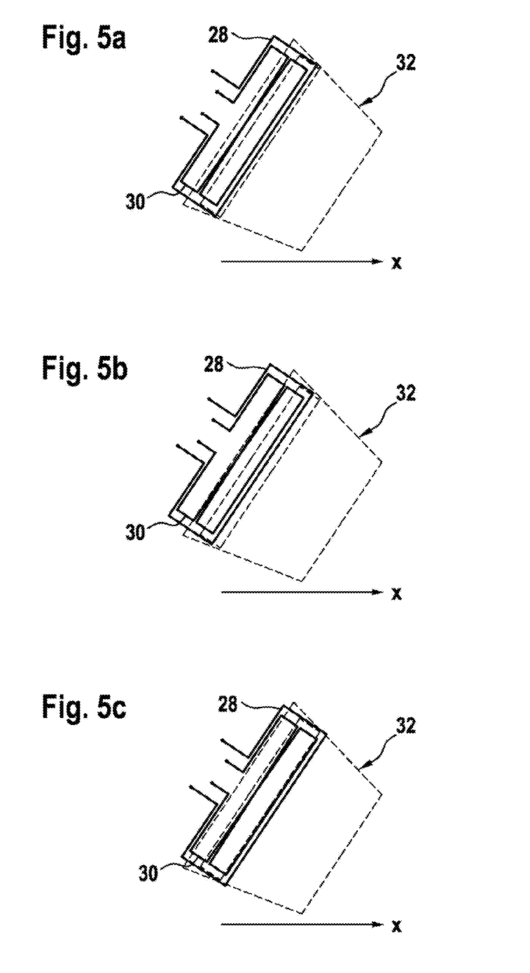

FIG. 4 schematically shows a view of an excerpt of the rotation angle sensor 10 according to the first form of embodiment. The at least one compensation receiving coil 30 has a first radial extent D1. The at least one first electrically conducting section 32 has a second radial extent D2. In this case the at least one first electrically conducting section 32 is bounded, viewed radially inward, by the gap 34 or the slot 34. The gap 34 or the slot 34 has a third radial extent D3.

The third radial extent D3 of the gap 34 or of the slot 34 is, in the radial direction, preferably at least 50% of the difference between the first radial extent D1 of the at least one compensation receiving coil 30 and a second radial extent D2 of the at least one first electrically conducting section 32.

In the place of the gap 34 or slot 34 or the circular ring-shaped at least one first electrically conducting section 32, another additional structure, which preferably is used exclusively for measuring the tolerances, can be provided.

Preferably, in the centered case, i.e. when the rotor element 14 and stator element 12 are centered with respect to the axis of rotation A and the at least one first electrically conducting section 32 is thus located in the nominal position, the at least one first electrically conducting section 32 is arranged centrally between counteractive windings 30a, 30b or partial windings 30a, 30b of the at least one compensation receiving coil 30. In the example, each winding 30a, 30b or partial winding 30a, 30b has a radial width or radial extent of 0.5×D1, i.e. half of the first radial extent D1. With a maximum excursion radially outward, the at least one first section 32 is located just still within the radially outer winding 30a or partial winding 30a. This is the case after a displacement of 0.5×(D1−D2), i.e. of half the difference between the first radial extent of the at least one compensation receiving coil 30 and the second radial extent D2 of the at least one first conducting section 32. For this displacement, the at least one second conducting section 26 is preferably not located over the at least one compensation receiving coil 30, or does not overlap the radially inner winding 30b or partial winding 30b of the at least one compensation receiving coil 30. For this purpose the gap width or the slot width of the gap 34 or of the slot 34 is chosen as described above.

The at least one first electrically conducting section 32 is here, as illustrated in FIG. 4, preferably less wide, i.e. has a lower second radial extent D2 than the at least one compensation receiving coil 30 which has a first radial extent D1. Thus preferably D2<D1. This improves the sensitivity for the recognition of tolerances.

Bearing play, or tolerances occurring as a result of manufacturing, allow(s) a relative displacement of the stator element 12 and the rotor element 14 radially with respect to the axis of rotation A. The measurement error associated with this when determining the rotation angle is described with reference to its position in the Cartesian coordinate system of FIG. 3. The axis of rotation A here represents the z-axis.

The arrangement of the at least one compensation transmitting coil 28 and the at least one compensation receiving coil 30 are bounded in the example by a circular arc segment. This, as is illustrated in FIG. 3, has an opening angle α=140° starting with the angular position δ=20°, which corresponds to the opening angle α of the surrounding angle detection transmitting coil 22 of the coil arrangement 23. The at least one first electrically conducting section 32, and the at least one second electrically conducting section 26 are located, as described, at the angle position δ with respect to the x-axis and with respect to an anticlockwise rotation around the axis of rotation A at the origin of a Cartesian coordinate system. Potentially occurring critical tolerances are a displacement in the x direction Δx and displacement in the y-direction Δy. Depending on the angle position δ these affect the measurement error of the rotation angle to different degrees.

At an angle position δ=90°, a displacement in the x-direction only corresponds directly to a rotation of the second electrically conducting section 26. If the rotor element 14 is displaced in this position along the x-axis, the rotation angle sensor 10 detects this displacement with the at least one angle detection receiving coil 20 as the rotation angle, since the rotor element 14 with its inductively coupling at least one second section 26 is displaced with respect to the at least one angle detection receiving coil 20. The alternating voltage signal thus changes. The rotation angle sensor 10 then assigns to this change a change of the rotation angle, without a rotation of the rotor element 14 with respect to the stator element 12 actually having taken place. In this position of the rotor element 14, the effect on the angle error to be expected is a maximum. This can be approximated by the relation

Δδx,max=360°·xπ·D

The influence of a y-tolerance Δy that occurs on the measurement error is minimal at this point, and can be neglected, since little or nothing changes in the degree of overlap of the at least one angle detection receiving coil 20 by the rotor element 14.

The contrary situation occurs if the at least one first electrically conducting section 26 is located at the radially extending boundary of the at least one angle detection receiving coil 20. This would be the case with a rotation angle δ of about 0° to 10° of the rotor element 14. The measurement error here is markedly more strongly dependent on the y-tolerance, and only minimally on the x-tolerance. This is because in this position, even with a small displacement in the y-direction, the rotor element 14 would bring about a large change in the degree of overlap with the at least one angle detection receiving coil 20. The rotation angle sensor 10, or the evaluation electronics coupled thereto, would detect this change in the overlap in the form of a changed induced angle detection alternating voltage, and accordingly would output a changed rotation angle—even though only a displacement in the y-direction between the rotor element 14 and the stator element 12 is present.

The following approximation applies here to the angular error:

Δδy,max=cos δ·Δδx,max=cos δ·360°·Δxπ·D

The errors occurring with real sensors as a result of x-tolerances and y-tolerances are, for example, recognizable and preferably avoided through an arrangement of at least one of the described compensation elements 1, 2, 3. Preferably a number of compensation elements 1, 2, 3 and of first electrically conducting sections 32 are in agreement.

Preferably at least two compensation receiving coils 30 are arranged at the stator element 12 in a predetermined circular segment between 0° and a maximum angle in the range from 170° to 190°, preferably 180°, wherein at least two first electrically conducting sections 32 are provided at the rotor element 14 in a predetermined circular segment between 0° and a maximum angle in the range from 170° to 190°. Alternatively or in addition, the at least two compensation receiving coils 30 and the at least two first electrically conducting sections 32 are arranged offset in the circumferential direction of the stator element 12 or of the rotor element 14 through a predetermined angle, in particular between 70 and 100°, preferably 90°.

In the first form of embodiment, the at least one compensation receiving coil 30 preferably comprises an identical number of first partial windings 30a and second partial windings 30b, that are arranged with respect to one another and with respect to the axis of rotation A in such a way that a first alternating voltage component is induced by the electromagnetic compensation alternating field in the first winding 30a or the first partial winding 30a, and a second alternating voltage component with the opposite arithmetic sign is induced in the second winding 30b or the second partial winding 30b, wherein the first alternating voltage component and the second alternating voltage component compensate each other in a predetermined radial arrangement of the at least one first electrically conducting section 32 with respect to the axis of rotation A.

FIGS. 5a, 5b and, 5c show schematic views of the relative arrangement of parts of the rotation angle sensor 10 according to the first form of embodiment. These result from appropriate relative positions of stator element 12 and rotor element 14 in the x-direction with respect to one another. In the arrangement according to FIG. 5a the at least one first electrically conducting section 32 lies in a symmetrical position with respect to the transition region of the first partial windings 30a and the second partial windings 30b. As a result the two alternating voltage components compensate one another, and the coupling factor is zero.

This means that the at least one first electrically conducting section 32 is located in the nominal position, i.e. no lateral or vertical offset of the at least one second electrically conducting section 26 with respect to the axis of rotation A is present.

If now the at least one first electrically conducting section 32 is displaced, for example in a negative x-direction (FIG. 5b), then the first electrically conducting section 32 increasingly overlaps the second partial winding 30b, and an inductive coupling in this part of the coil is suppressed. An induced voltage in the first partial winding 30a remains, and the coupling factor is positive.

FIG. 5c shows the opposing case for a displacement of the at least one first electrically conducting section 32 in the positive x-direction. A negative coupling factor therefore accordingly results.

Preferably at least two of the compensation receiving coils 30 are arranged outside the angle detection receiving coil measuring region. When the at least two compensation receiving coils 30 are used, at least two of these compensation receiving coils can particularly advantageously be arranged in a non-collinear manner with respect to the axis of rotation A. In other words: at least two of the plurality of compensation receiving coils 30 do not lie on a straight line on which the axis of rotation A also lies. By measuring the two coupling factors, it is thereby possible to back-calculate the x-offset and the y-offset of the second electrically conducting region 26. The position of the second electrically conducting region 26 is thereby known at any time. Preferably an incorrect angle signal is accordingly corrected.

Instead of the described design of the at least one compensation receiving coil 30, the first winding 30a, the first partial windings 30a, the second winding 30b or the second partial windings 30b, other forms are also possible. For example, the first winding 30a or the first partial windings 30a and second winding 30b or the second partial windings 30b do not have to extend over rectangular surfaces when viewed from above. Furthermore, the number of windings of the at least one compensation transmitting coil 28 or of the at least one compensation receiving coil 30 can be greater than one. In addition, the at least one compensation receiving coil 30 can be arranged closer to the axis of rotation A than the at least one compensation transmitting coil 28 of the coil arrangement 23. Alternatively, the at least one compensation receiving coil 30 can be arranged at a greater distance from the axis of rotation A than the at least one compensation transmitting coil 28.

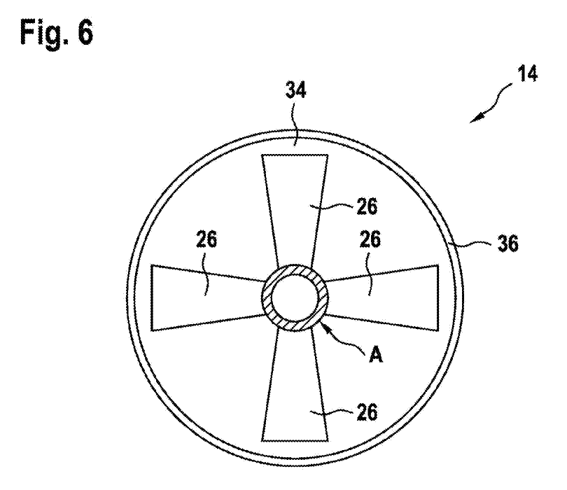

FIG. 6 shows schematically a part of a rotation angle sensor 10 according to a second form of embodiment. This comprises the rotor element 14, which is arranged at the stator element 12 as described for the first form of embodiment. In contrast to the first form of embodiment, the rotor element 14 according to the second form of embodiment comprises an electrically conducting circular ring 36 extending in the circumferential direction instead of the at least one first electrically conducting section 32.

The electrically conducting circular ring 36 extending in the circumferential direction is separated from the at least one second electrically conducting section 26 by a gap 34 or a slot 34. Viewed in the radial direction, that is to say, in the direction toward the axis of rotation A, the at least one second electrically conducting section 26 is arranged between the axis of rotation A and the surrounding electrically conductive circular ring 36. Viewed in the radial direction, the gap 34 or slot 34, which for example has the form of a circular ring sector, preferably extends between the at least one second electrically conducting section 26 and the surrounding electrically conductive circular ring 36 in the circumferential direction. Viewed in the circumferential direction, for example four second electrically conducting sections 26 are provided that extend along spokes at a spacing of 90° to one another radially from the axis of rotation A to the surrounding electrically conductive circular ring 36. More or fewer second electrically conducting sections 26 can also be provided.

The at least one second electrically conducting section 26 of the rotor element 14, the coil arrangement 23 and the compensation elements 1, 2, 3 of the stator element 12 are, for example, arranged as described in the first form of embodiment. The surrounding electrically conductive circular ring 36 is, for example, arranged radially at the same distance from the axis of rotation A as the at least one first electrically conducting section 32 of the first form of embodiment. The gap 34 or the slot 34 has for example the same dimensions in both forms of embodiment.

Preferably, the coil arrangement 23, in contrast to the first form of embodiment, surrounds the axis of rotation A, i.e. the opening angle is α=360°. The measuring range β of the rotation angle sensor 10 is then, for example, β=360°. For example, four compensation elements at a spacing of 90° are accordingly arranged here.

1. A rotation angle sensor, comprising:
a stator element; and,
a rotor element mounted rotatably about an axis of rotation with respect to the stator element, wherein a rotation angle is detected by an inductive coupling between the rotor element and the stator element,
wherein:
at least one compensation element is arranged at the stator element,
the at least one compensation element comprises at least one compensation transmitting coil, configured to emit an electromagnetic compensation alternating field, and at least one compensation receiving coil, configured to receive electromagnetic alternating fields,
the rotor element comprises at least one first electrically conducting section, and
the at least one first electrically conducting section is arranged at the rotor element such that, and is inductively coupled with the at least one compensation transmitting coil and the at least one compensation receiving coil of the compensation element such that, when the electromagnetic compensation alternating field is emitted by the at least one compensation transmitting coil, a compensation alternating voltage induced in the at least one first compensation receiving coil depends predominantly on a relative radial arrangement of the stator element and of the rotor element to one another with respect to the axis of rotation.

2. The rotation angle sensor as claimed in claim 1, wherein:
the stator element comprises at least one angle detection transmitting coil configured to emit an electromagnetic angle detection alternating field, and at least one angle detection receiving coil configured to detect electromagnetic alternating fields,
the rotor element comprises at least one second electrically conducting section,
the at least one second electrically conducting section is a circular ring sector with respect to the axis of rotation,
the at least one second electrically conducting section is inductively coupled with the at least one angle detection receiving coil such that, when the electromagnetic angle detection alternating field is emitted by the at least one angle detection transmitting coil, at least one first alternating voltage is induced in the at least one angle detection receiving coil, and
the at least one second electrically conducting section is arranged at the rotor element such that the first alternating voltage induced in the at least one angle detection receiving coil depends predominantly on a rotation angle between the stator element and the rotor element.

3. The rotation angle sensor as claimed in claim 2, wherein one of the at least one compensation element and the at least one compensation receiving coil lies radially outside the at least one angle detection receiving coil.

4. The rotation angle sensor as claimed in claim 2, wherein the at least one compensation transmitting coil, configured to generate the compensation alternating field, and the at least one angle detection transmitting coil, configured to generate the angle detection alternating field, are arranged at the stator element.

5. The rotation angle sensor as claimed in claim 1, wherein:
a winding of the at least one compensation receiving coil is arranged with respect to the at least one first electrically conducting section radially with respect to the axis of rotation at least partially overlapping with the at least one first electrically conducting section, and
a radial extent of the at least one first electrically conducting section is smaller than a radial extent of the at least one compensation receiving coil.

6. The rotation angle sensor as claimed in claim 1, wherein the at least one first electrically conducting section is an electrically conductive circular ring surrounding the rotor element in the circumferential direction.

7. The rotation angle sensor as claimed in claim 2, wherein:
the at least one first electrically conducting section extends radially from the axis of rotation,
the at least one second electrically conducting section abuts the at least one first electrically conducting section radially, extending in the direction of the axis of rotation,
the at least one second electrically conducting section is arranged, viewed in the radial direction, between the axis of rotation and the at least one first electrically conducting section, and
viewed in the radial direction, a slot formed as a circular ring sector, extending in the circumferential direction, is provided between the at least one second electrically conducting section and the at least one first electrically conducting section.

8. The rotation angle sensor as claimed in claim 7, wherein an extent of the slot in the radial direction is at least 50% of the difference between a radial extent of the at least one compensation receiving coil and a radial extent of the at least one first electrically conducting section.

9. The rotation angle sensor as claimed in claim 7, wherein:
the at least one second electrically conducting section and the at least one first electrically conducting section form a surface, formed as a circular ring sector, abutting one another radially with respect to the axis of rotation, and
the at least one first electrically conducting section comprises the slot.

10. The rotation angle sensor as claimed in claim 1, wherein:
the at least one compensation receiving coil comprises an identical number of first partial windings and second partial windings which are arranged with respect to one another and with respect to the axis of rotation such that a first alternating voltage component is induced in the first partial winding by the electromagnetic compensation alternating field, and a second alternating voltage component with the opposite arithmetic sign is induced in the second partial winding, and
in a predetermined radial arrangement of the at least one first electrically conducting section with respect to the axis of rotation, the first alternating voltage component and the second alternating voltage component compensate one another.

11. The rotation angle sensor as claimed in claim 1, wherein a number of at least one compensation element and at least one first electrically conducting section are in accordance.

12. The rotation angle sensor as claimed in claim 10, wherein:
at least two compensation receiving coils are arranged at the stator element in a predetermined circular segment between 0° and a maximum angle in the range from 170° to 190°,
at least two first electrically conducting sections are provided at the rotor element in a predetermined circular segment between 0° and a maximum angle in the range of 170° to 190°, and/or
the at least two compensation receiving coils and the at least two first electrically conducting sections are arranged offset in the circumferential direction of the stator element or of the rotor element by a predetermined angle between 70 and 100°.

13. A stator element for a rotation angle sensor, comprising:
at least one compensation transmitting coil configured to emit an electromagnetic compensation alternating field, wherein:
at least one compensation element is arranged at the stator element,
the at least one compensation element comprises the at least one compensation transmitting coil and at least one compensation receiving coil, for receiving which is configured to receive electromagnetic alternating fields,
a rotor element is mounted rotatably about an axis of rotation with respect to the stator element such that a rotation angle is detected by an inductive coupling between the rotor element and the stator element,
the rotor element comprises at least one first electrically conducting section, and
the at least one first electrically conducting section is arranged at the rotor element such that, and is coupled inductively with the at least one compensation transmitting coil such that, when the electromagnetic compensation alternating field is emitted by the at least one compensation transmitting coil, a compensation alternating voltage induced in the at least one compensation receiving coil depends predominantly on a relative radial arrangement of the stator element and of the rotor element to one another with respect to the axis of rotation.

14. A rotor element for a rotation angle sensor, comprising:
at least one first electrically conducting section, wherein:
the rotor element is mounted rotatably with respect to a stator element about an axis of rotation,
at least one compensation element is arranged at the stator element,
the at least one compensation element comprises at least one compensation transmitting coil, configured to emit an electromagnetic compensation alternating field, and at least one compensation receiving coil, configured to receive electromagnetic alternating fields, and
the at least one first electrically conducting section is arranged at the rotor element such that, and is coupled inductively with the compensation transmitting coil such that, when the electromagnetic compensation alternating field is emitted by the at least one compensation transmitting coil, a compensation alternating voltage induced in the at least one compensation receiving coil depends predominantly on a relative radial arrangement of the stator element and the rotor element with respect to one another with respect to the axis of rotation.
